(19) United States
(12) Patent Application Publication
(10) Pub. No.: US 2025/0078060 A1
(43) Pub. Date: Mar. 6, 2025

(54) ELECTRONIC RECEIPT DISPENSING SYSTEM, INFORMATION PROCESSING APPARATUS, AND ELECTRONIC RECEIPT DISPENSING METHOD

(71) Applicant: Toshiba Tec Kabushiki Kaisha, Tokyo (JP)

(72) Inventor: Seiya GOTOU, Izunokuni Shizuoka (JP)

(21) Appl. No.: 18/787,517

(22) Filed: Jul. 29, 2024

(30) Foreign Application Priority Data
Aug. 28, 2023 (JP) 2023-138259

(51) Int. Cl. G06Q 20/20

(52) U.S. Cl. CPC G06Q 20/209; G06Q 20/202

(57) ABSTRACT

A sales transaction processing system includes a point-of-sale terminal in a store, a printer for printing transaction receipts, and a transaction system server connected to the point-of-sale terminal via a network. The server receives a commodity code of an item being registered for purchase in a sales transaction at the point-of-sale terminal and registers the item in transaction data for the sales transaction, receives a member code for a customer, generates printing data for printing a transaction receipt for the sales transaction on the printer, and, if the received member code indicates the customer is a member of an electronic receipt service, generates linkage data from the printing data. The linkage data permits an electronic receipt to be generated for the sales transaction either presently or subsequently.

### CROSS-REFERENCE TO RELATED APPLICATION

This application is based upon and claims the benefit of priority from Japanese Patent Application No. 2023-138259, filed Aug. 28, 2023, the entire contents of which are incorporated herein by reference.

### FIELD

Embodiments described herein relate generally to an electronic receipt dispensing system, an information processing apparatus for such a system, and an electronic receipt dispensing method.

### BACKGROUND

An electronic receipt for replacing a paper medium receipt (a paper receipt) has been put into practical use. The electronic receipt is displayed by a terminal apparatus and enables review of content of a transaction.

In the related art, during processing for dispensing a receipt at the end of a sales transaction, if printing data for the receipt includes specific character information therein, an electronic receipt (or data therefor) is generated instead of a paper receipt. The electronic receipt can then be displayed on a terminal apparatus. The specific character information (also referred to as a flag or trigger characters) can be inserted into the printing data if the customer is a member of an electronic receipt service (an electronic receipt member) who has indicated a preference for electronic receipts over paper receipts.

In the processing explained above, the timing at which the electronic receipt data can be generated (and dispensed) is limited. That is, it may be difficult to dispense an electronic receipt after the receipt dispensing processing executed for the transaction processing has already ended.

In order to eliminate such difficulties and make electronic receipts and services providing electronic receipts easier to use, a system for improving flexibility and versatility in the dispensing timing of electronic receipts is described.

### BRIEF DESCRIPTION OF THE DRAWINGS

FIG. 1 is a diagram illustrating an example of a configuration of a system in a first embodiment.

FIG. 2 is a block diagram illustrating an example of a configuration of a transaction system server.

FIG. 3 is a block diagram illustrating an example of a configuration of an electronic receipt server.

FIG. 4 is a block diagram illustrating an example of a configuration of a tablet POS.

FIG. 5 is a block diagram illustrating an example of information stored by a database.

FIG. 6 is a diagram illustrating an example of HTML data stored by a database.

FIG. 7 is a diagram illustrating an example of paper receipt printing data stored by a database.

FIG. 8 is a diagram illustrating an example of display content of a paper receipt printed by a printer.

FIG. 9 is a diagram illustrating an example of electronic receipt linkage data stored by a database.

FIG. 10 is a block diagram illustrating an example of functional aspects of a control unit.

FIG. 11 is a diagram illustrating aspects of processing executed by a control unit.

FIG. 12 is a diagram illustrating aspects of processing executed by a control unit of a tablet POS.

FIG. 13 is a diagram illustrating aspects of processing executed by a control unit of a transaction system server.

FIG. 14 is a diagram illustrating an example of a transaction completion screen displayed by a tablet POS.

FIG. 15 is a diagram illustrating an example of a balance screen displayed by a tablet POS.

FIG. 16 is a block diagram illustrating an example of functional aspects of a control unit in a second embodiment.

FIG. 17 is a diagram illustrating an example of electronic receipt linkage data stored by a database in a third embodiment.

### DETAILED DESCRIPTION

Certain example embodiments provide a system, an information processing apparatus, and an electronic receipt dispensing method high having flexibility and improved versatility in the technology context of electronic receipt dispensing and electronic receipt services.

According to one embodiment, a sales transaction processing system includes a point-of-sale terminal in a store, a printer in the store for printing transaction receipts, and a transaction system server connected to the point-of-sale terminal via a first network. The server is configured to: receive a commodity code of an item being registered for purchase in a sales transaction at the point-of-sale terminal and register the item in transaction data for the sales transaction; receive a member code for a customer in the sales transaction; generate printing data for printing a transaction receipt for the sales transaction on the printer, the transaction receipt being based on the transaction data for the sales transaction; and, if the received member code indicates the customer is a member of an electronic receipt service, generate linkage data from the printing data. The linkage data permits an electronic receipt to be generated for the sales transaction.

### First Embodiment

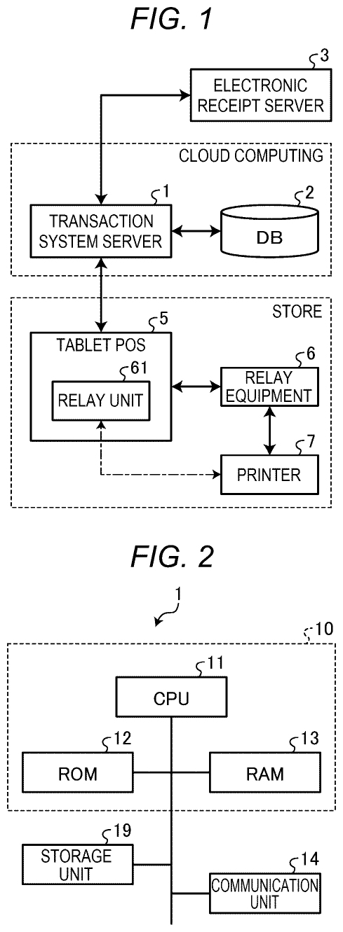

FIG. 1 is a diagram illustrating an example of a configuration of a system in this first embodiment. The system in this first embodiment includes a transaction system server 1, a database 2 (DB 2), an electronic receipt server 3, a tablet POS 5, relay equipment 6, and a printer 7.

The tablet POS 5 is a type of a point-of-sale (POS) terminal provided in a store. The POS terminal is an example of a sales data processing apparatus that performs commodity registration, registered commodity settlement, and the like.

The store may include POS terminals of types other than the tablet POS 5. Examples of the POS terminals of other types include a stationary general POS register operated by a store clerk, a self-service checkout apparatus, and a semi-self-service checkout apparatus. The self-service checkout apparatus is an apparatus by which a customer performs operations relating to commodity registration and settlement by himself or herself. The semi-self-service checkout apparatus is an apparatus by which the customer performs operations relating to settlement by himself or herself for items registered by the store clerk at a different apparatus or the like.

The relay equipment 6 relays data between the tablet POS 5 and peripherals such as the printer 7. For example, the relay equipment 6 transmits an instruction received from the tablet POS 5 to the printer 7 which causes the printer 7 to dispense a receipt.

Note that in some examples the tablet POS 5 may include a relay unit 61 that acts or functions in the same manner as the relay equipment 6. The relay equipment 6 and the relay unit 61 are selectably used, for example, if it is desired to use the peripherals such as the printer 7 by wired connection, the peripherals are connected to the relay equipment 6 by wire and wireless communication is performed between the relay equipment 6 and the tablet POS 5. If the peripherals, such as the printer 7, are wirelessly communicable, wireless communication can be performed between the peripherals and the relay unit 61.

The printer 7 dispenses printed matter such as a receipt (a printed receipt). The printer 7 incorporates a printing unit and roll paper. The printing unit is configured by a printing head and a platen roller. The platen roller holds, between the platen roller and the printing head, paper drawn out from the roll paper and rotates to thereby convey the paper. The printing head prints characters (text), a logo image, and the like on the conveyed paper.

The transaction system server 1 and the DB 2 are interposed between POS terminals (for example, the tablet POS 5) of the store and the electronic receipt server 3. The transaction system server 1 and DB 2 provide cloud computing services to the POS terminals and the electronic receipt server 3 and mediates data linkages between the POS terminals and the electronic receipt server 3. The transaction system server 1 is capable of referring to information stored in the DB 2 and updates the information stored in the DB 2.

The transaction system server 1 receives information concerning a transaction performed at a POS terminal of the store (transaction information) and causes the DB 2 to store the information (the transaction information). The transaction system server 1 generates, according to instructions received from the POS terminal of the store, HTML data, paper receipt printing data, and electronic receipt linkage data corresponding to the transaction information received. The transaction system server 1 transmits the generated paper receipt printing data to the printer 7 and transmits the generated electronic receipt linkage data to the electronic receipt server 3.

When the electronic receipt linkage data is received from the transaction system server 1, the electronic receipt server 3 generates electronic receipt data and accumulates (stores) the electronic receipt data. The electronic receipt server 3 provides, in response to a reference request from a terminal apparatus used by a customer, the electronic receipt requested by the customer.

FIG. 2 is a block diagram illustrating an example of a configuration of the transaction system server 1. The transaction system server 1 includes a CPU (Central Processing Unit) 11, a ROM (Read Only Memory) 12, a RAM (Random Access Memory) 13, a communication unit 14, and a storage unit 19.

The CPU 11 is an example of a processor and comprehensively controls the units of the transaction system server 1. The ROM 12 stores various programs. The RAM 13 is a work space in which programs and various data are loaded. The CPU 11, the ROM 12, and the RAM 13 are connected via a bus or the like and configure a control unit 10 having a computer configuration.

The communication unit 14 is a communication interface that communicably connects the control unit 10 and external apparatuses (for example, the tablet POS 5 and the electronic receipt server 3) via a network.

The storage unit 19 includes a storage medium such as an HDD (Hard Disk Drive) or a flash memory and maintains stored content even if a power supply is shut off. The storage unit 19 stores programs executable by the CPU 11 and various kinds of setting information.

The CPU 11 operates according to a program stored in the ROM 12 or the storage unit 19 and then loaded in the RAM 13, whereby the control unit 10 executes various kinds of processing according to the program instructions. Accordingly, the control unit 10 provides various functions or functional units. These various functional units are, for example, a transaction start processing unit 101, a member information processing unit 102, a commodity registration processing unit 103, a settlement processing unit 104, a transaction information storage processing unit 105, and a receipt output processing unit 106 explained below (see FIG. 10).

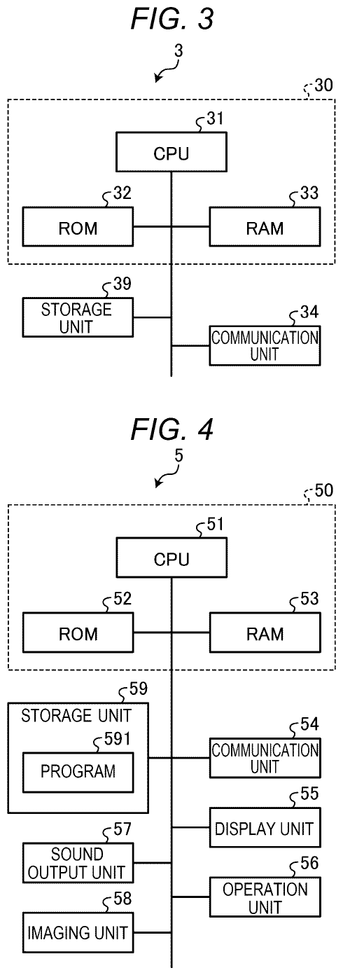

FIG. 3 is a block diagram illustrating an example of a configuration of the electronic receipt server 3. The electronic receipt server 3 includes a CPU 31, a ROM 32, a RAM 33, a communication unit 34, and a storage unit 39.

The CPU 31 is an example of a processor and comprehensively controls the units of the electronic receipt server 3. The ROM 32 stores various programs. The RAM 33 is a work space in which programs and various data are loaded. The CPU 31, the ROM 32, and the RAM 33 are connected via a bus or the like and configure a control unit 30 having a computer configuration.

The communication unit 34 is a communication interface that communicably connects the control unit 30 and external apparatuses (for example, the transaction system server 1) via a network.

The storage unit 39 includes a storage medium such as an HDD or a flash memory and maintains stored content even if a power supply is shut off. The storage unit 39 stores programs executable by the CPU 31 and various kinds of setting information. The storage unit 39 also stores electronic receipt member information. The electronic receipt member information is stored in the DB 2, for example, in a table format.

The electronic receipt member information is member information (names, contacts, and the like) of electronic receipt members in correlation with member codes that are unique codes for the electronic receipt member service. The member codes are an example of identification information capable of identifying the electronic receipt members.

Note that electronic receipt member identification information (also referred to as member flag) indicating whether a customer is an electronic receipt member in the system can be extracted from a member code included in the electronic receipt member information. For example, if at least a part of the member code of electronic the receipt member information is a predetermined number indicating that the is customer an electronic receipt member, the control units of the apparatuses included in the system determine that the customer presenting the commodity code is an electronic receipt member.

The CPU 31 operates according to a program stored in the ROM 32 or the storage unit 39 and then loaded in the RAM 33, whereby the control unit 30 executes various kinds of processing according to program instructions. For example, the control unit 30 provides, an API (Application Programming Interface) 306 (see FIG. 10).

FIG. 4 is a block diagram illustrating an example of a configuration of a tablet POS 5. Note that the POS terminals of the other types in the store have configurations generally similar to the tablet POS 5. Each tablet POS 5 includes a CPU 51, a ROM 52, a RAM 53, a communication unit 54, a display unit 55, an operation unit 56, a sound output unit 57, an imaging unit 58, and a storage unit 59.

The CPU 51 is an example of a processor and comprehensively controls the units of the tablet POS 5. The ROM 52 stores various programs. The RAM 53 is a work space in which programs and various data are loaded. The CPU 51, the ROM 52, and the RAM 53 are connected via a bus or the like and configure a control unit 50 having a computer configuration.

The communication unit 54 is a communication interface that communicably connects the control unit 50 and external apparatuses (for example, the relay equipment 6 and the electronic receipt server 3) via a network.

The display unit 55 incorporates a display device such as an LCD (Liquid Crystal Display) and displays various kinds of information under the control of the CPU 51.

The operation unit 56 incorporates an input device such as a touch panel superimposed on the surface of the display unit 55 and outputs user input operations and selections made via the input device to the CPU 51. Note that an input device included in a POS terminal may also be a keyboard, a pointing device, or the like.

The sound output unit 57 includes a speaker and/or a buzzer and outputs sound under the control of the CPU 51.

The imaging unit 58 incorporates an imaging element such as a CCD (Charge Coupled Device) or a CMOS (Complementary MOS). The imaging unit 58 can be used to acquire images of a code symbol such as a barcode or a two-dimensional code attached to a commodity. The imaging unit 58 may also be considered to acquire a code symbol for a commodity encoded in a barcode or two-dimensional code image. Note that the imaging unit 58 is a type of an input device. The code symbol image acquired by the imaging unit 58 is decoded into code information.

The storage unit 59 includes a storage medium such as an SSD (Solid-State Drive) or a flash memory and maintains stored content even if a power supply is shut off. The storage unit 59 stores programs executable by the CPU 51 and various kinds of setting information.

The CPU 51 operates according to a program stored in the ROM 52 or the storage unit 59 and then loaded in the RAM 53, whereby the control unit 50 executes various kinds of processing according to program instructions. Accordingly, the control unit 50 provides various functions or functional units. The various functional units are, for example, a transaction start processing unit 501, a member information processing unit 502, a commodity registration processing unit 503, and a settlement processing unit 504 (see FIG. 10).

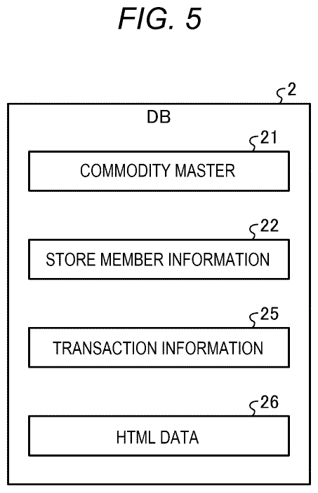

FIG. 5 is a block diagram illustrating an example of information stored by the DB 2. The DB 2 (as an example of a storage unit or a transaction information storage unit) stores various kinds of information to be referred to or updated by the transaction system server 1. The information stored by the DB 2 includes, for example, commodity master 21, store member information 22, transaction information 25, and HTML data 26.

The commodity master 21 is information about commodities offered by a store. In the commodity master 21, commodity names, unit prices, and the like are stored in correlation with commodity codes or the like. The commodity codes are an example of identification information capable of identifying commodities and are, for example, JAN (Japanese Article Number) codes.

The store member information 22 can be stored in the DB 2 in a table format or the like.

The store member information 22 stores member information (names, contacts, and the like) of so called “store members” (e.g., members of a store's customer loyalty program or the like) in correlation with member codes (store member codes or program member codes) that are unique codes in the store member information 22. These store member codes in the store member information 22 are an example of identification information capable of identifying the store members.

The transaction information 25 can be text data that the transaction system server 1 caused the DB 2 to store. A file format of the transaction information 25 in this embodiment can be a JSON format (Java Script Object Notation). The transaction information 25 includes, for example, header information, footer information, and commodity information. The commodity information includes a commodity code, a commodity name, a unit price, e number of purchased items and is generally positioned between the header information and the footer information. The header information or the footer information includes a transaction ID. The transaction ID is an example of information capable of specifying a particular transaction.

The HTML data 26 is an example of structured data. The HTML data 26 is information that the control unit 10 of the transaction system server 1 generates by performing editing (conversion) such as adding an HTML data tag to the transaction information 25 in the JSON format (thus structuring the transaction information 25) and then causes to be stored in the DB 2.

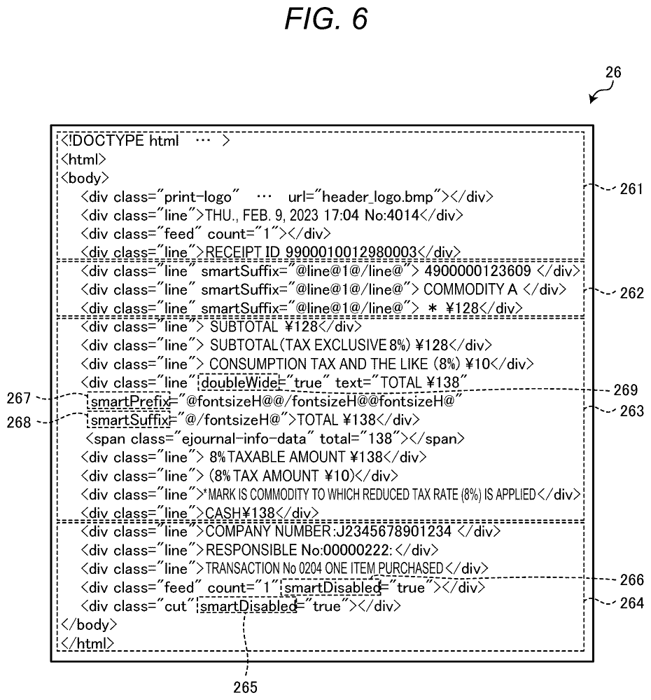

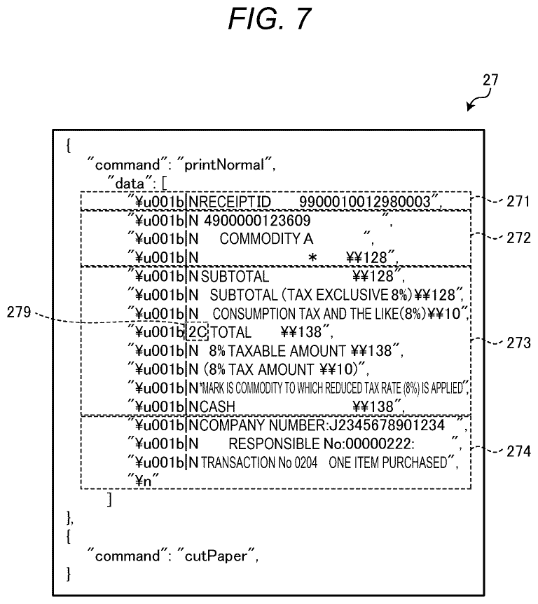

FIG. 6 is a diagram illustrating an example of the HTML data 26 stored in the DB 2. The HTML data 26 includes header information 261, commodity information 262, adjustment information 263, and footer information 264.

The header information 261 includes an HTML tag added to the header information of the transaction information 25. The footer information 264 includes an HTML tag added to the footer information of the transaction information 25. The commodity information 262 includes an HTML tag added to the commodity information of the transaction information 25. In FIG. 6, there is just one piece of commodity information 262 because just one commodity was purchased in the corresponding transaction. However, the commodity information 262 continues and includes multiple pieces if a plurality of commodities are purchased in the transaction. The adjustment information 263 in this context is various amounts, sub-totals, values, and the like calculated based on the commodity information in the transaction information 25. For example, a tax rate and tax amount along with various notes concerning the various amounts, sub-totals, values, and tax rate, and the like can be included in the adjustment information.

Information used for paper receipt printing data 27 and information used for electronic receipt linkage data 28 are included in the HTML data 26 with HTML tags.

For example, a “class” attribute of a “<div>” tag indicates the information used for the paper receipt printing data 27. Further, “class=” line”” is used for designation concerning printing for one row. “class=” feed”” is used for designation concerning paper conveyance. “class=” cut”” indicates designation for cutting paper. “class=” print-log”” is used for designation concerning logo printing. Note that the logo can be stored in the DB 2 and the storage unit 19 of the transaction system server 1 as image data such as a bitmap file.

The “smartDisabled” attributes 265 and 266 of the “<div>” tag are used to indicate information unnecessary for the electronic receipt linkage data 28. A “smartPrefix” attribute 267 of the “<div>” tag is used to add information necessary for the electronic receipt linkage data 28 to the head of a portion surrounded by the tag. Further, a “smartSuffix” attribute 268 of the “<div>” tag is used to add information necessary for the electronic receipt linkage data 28 to the tail of the portion surrounded by the tag. Note that the information added by the attributes 267 and 268 can be such things as a designation for increasing a font size of the portion (a row indicating a total) surrounded by the “<div>” tag in displaying an electronic receipt.

A “doubleWide” attribute 269 of the “<div>” tag is used to add a designation for increasing a font size to a double width (using a double width size) in printing a portion surrounded by the tag.

The control unit 10 of the transaction system server 1 edits (converts) the HTML data 26, generates the paper receipt printing data 27 thereby, and causes the RAM 13 or the like to temporarily store the paper receipt printing data 27.

FIG. 7 is a diagram illustrating an example of the paper receipt printing data 27 generated by the control unit 10. The paper receipt printing data 27 is generated by editing the HTML data 26. The paper receipt printing data 27 is data used by the printer 7 to print a paper receipt.

The paper receipt printing data 27 includes header information 271, commodity information 272, adjustment information 273, and footer information 274. Contents of the header information 271, the commodity information 272, the adjustment information 273, and the footer information 274 generally correspond to the header information 261, the commodity information 262, the adjustment information 263, and the footer information 264 included in the HTML data 26. The paper receipt printing data 27 includes information 279 corresponding to the attribute 269. The characters “2C”, which are labeled as information 279 in FIG. 7, indicates that, while a font used for printing other rows is normal “N”, a font used for printing a row with 2C (e.g., the row of a transaction total) is to be a double size.

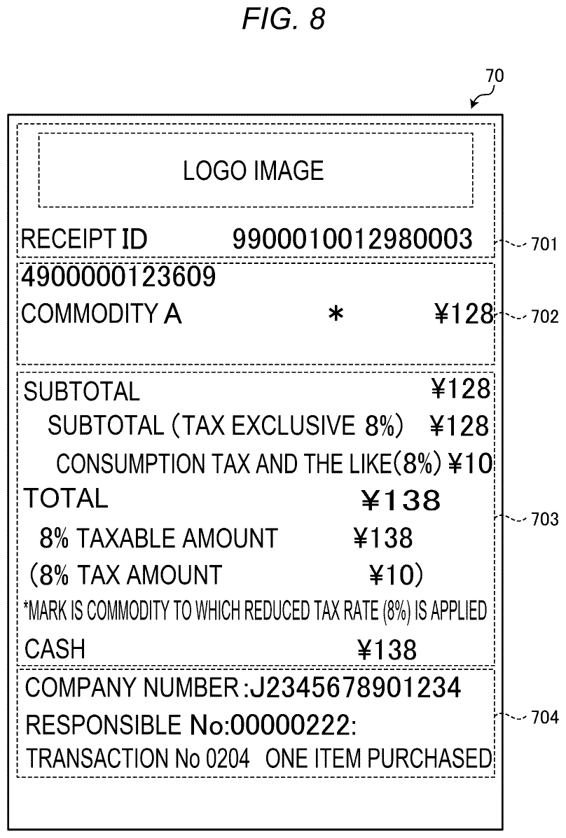

A paper receipt output by the printer 7 based on the paper receipt printing data 27 can be as illustrated in FIG. 8. FIG. 8 is a diagram illustrating an example of display content 70 of a paper receipt output by the printer 7.

The display content 70 of the paper receipt includes header information 701, commodity information 702, adjustment information 703, and footer information 704. Contents of the header information 701, the commodity information 702, the adjustment information 703, and the footer information 704 correspond to the header information 271, the commodity information 272, the adjustment information 273, and the footer information 274.

The control unit 10 edits (converts) the transaction information 25, generates the electronic receipt linkage data 28, and causes the RAM 13 or the like to temporarily store the electronic receipt linkage data 28.

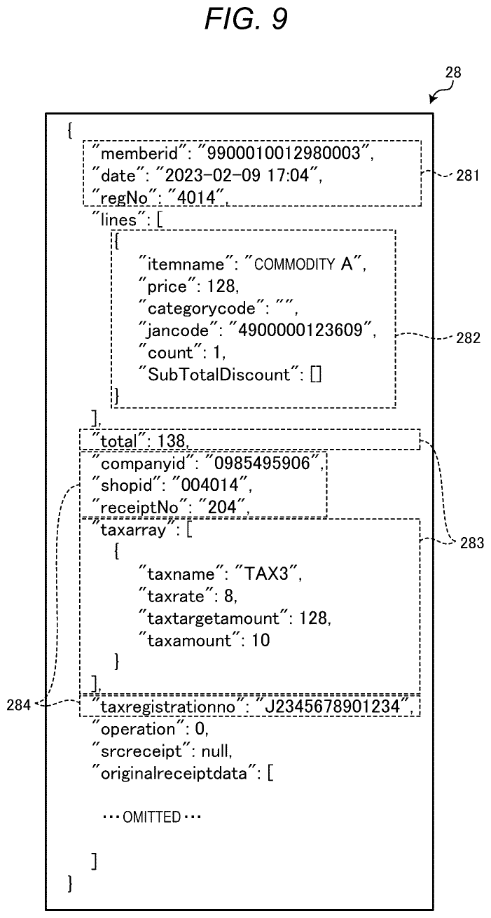

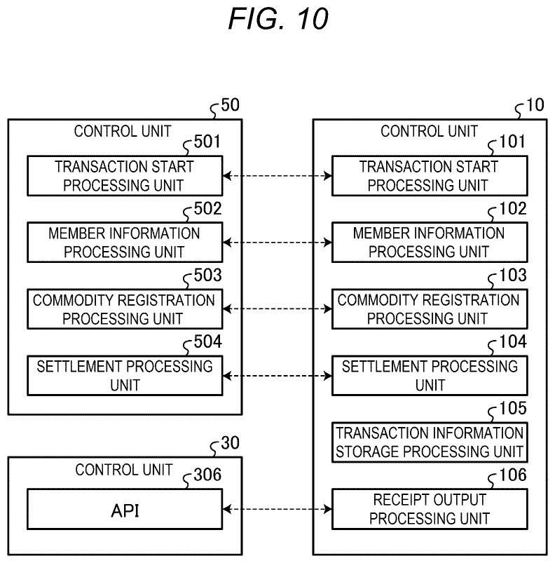

FIG. 9 is a diagram illustrating an example of the electronic receipt linkage data 28 generated by the control unit 10. The electronic receipt linkage data 28 can be generated from the transaction information 25. The electronic receipt linkage data 28 is the data transmitted to the electronic receipt server 3 and is used by the electronic receipt server 3 to generate an electronic receipt (electronic receipt data).

The electronic receipt linkage data 28 includes header information 281, commodity information 282, adjustment information 283, and footer information 284. Contents of the header information 281, the commodity information 282, the adjustment information 283, and the footer information 284 generally correspond to the header information 271, the commodity information 272, the adjustment information 273, and the footer information 274 included in the paper receipt printing data 27. Note that display order of the information 281 to the information 284 can be adjusted to match or correspond to a database structure used by the electronic receipt server 3.

After the electronic receipt linkage data 28 is received, the electronic receipt server 3 can generate new electronic receipt data based on the received electronic receipt linkage data 28. In this context, generating electronic receipt data refers broadly to registering the electronic receipt data in the electronic receipt server 3 as a newly available receipt or the like. The electronic receipt data permits a customer to use a terminal apparatus to view an electronic receipt. In general, the electronic receipt data allows a terminal apparatus used by the customer to display the electronic receipt.

FIG. 10 is a block diagram illustrating an example of functional components provided by the control units 10, 30, and 50. The control unit 50 of the tablet POS 5 includes a transaction start processing unit 501, a member information processing unit 502, a commodity registration processing unit 503, and a settlement processing unit 504. The control unit 10 of the transaction system server 1 includes a transaction start processing unit 101, a member information processing unit 102, a commodity registration processing unit a 103, settlement processing unit 104, a transaction information storage processing unit 105, and a receipt output processing unit 106. The control unit 30 of the electronic receipt server 3 includes an API 306 for generating electronic receipt data.

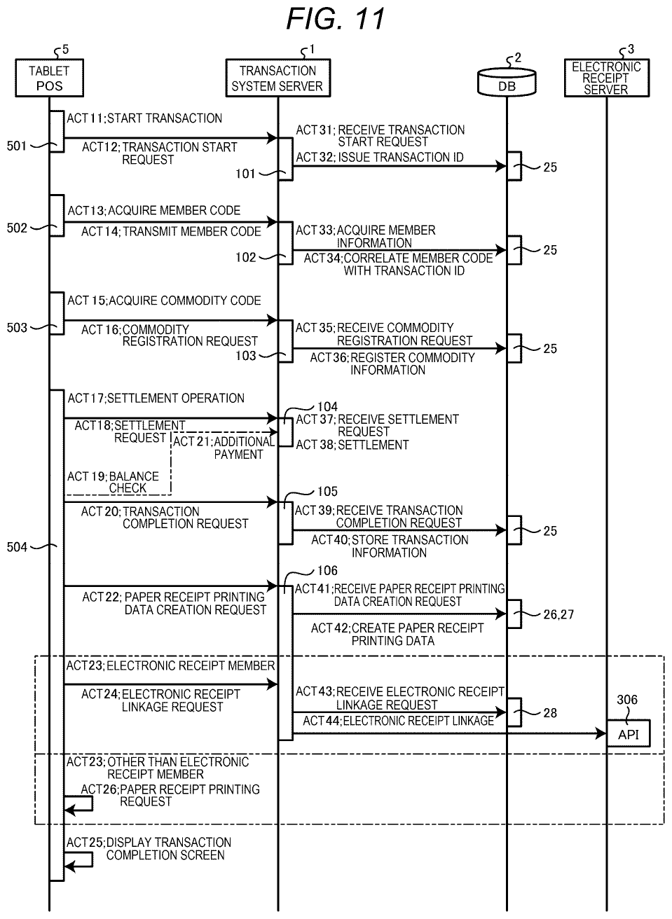

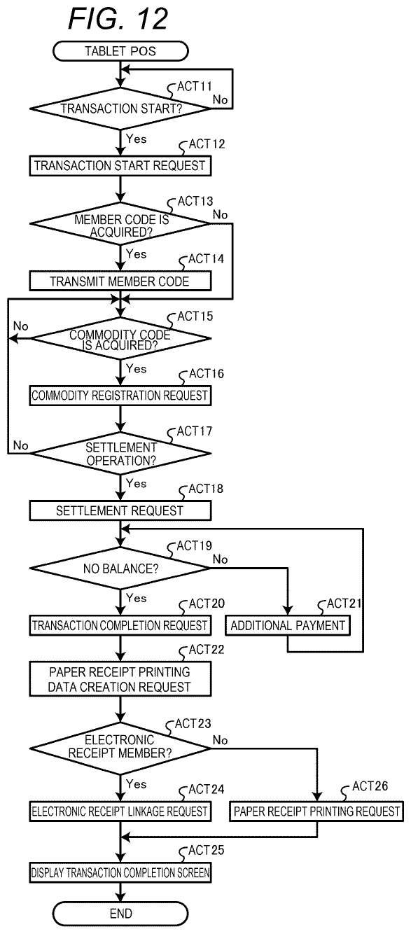

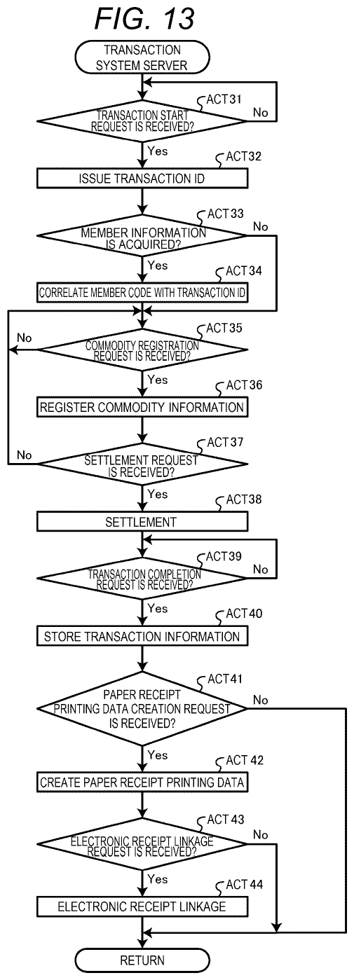

FIG. 11 is a diagram illustrating an example of processing executed by the control units 10, 30, and 50. As illustrated in FIGS. 10 and 11, the control units 10, 30, and 50 perform the overall processing in cooperation with each other. Note processing labeled with act numbers in FIG. 11 correspond to the same act numbers in FIGS. 12 and 13.

The transaction start processing unit 101, the member information processing unit 102, the commodity registration processing unit 103, and the settlement processing unit 104 included in the transaction system server 1 operate according to operations of the transaction start processing unit 501, the member information processing unit 502, the commodity registration processing unit 503, and the settlement processing unit 504.

That is, the transaction start processing unit 101 and the transaction start processing unit 501 perform transaction start processing in cooperation (ACTS 11, 12, 31, and 32). A transaction ID is issued in the transaction start processing.

Similarly, the member information processing unit 102 and the member information processing unit 502 function as an example of a member information acquiring unit that acquires, in commodity registration, electronic receipt member identifying information and perform member information processing in cooperation (ACTS 13, 14, 33, and 34). The member information processing operates in response to acquisition of a member code. In the member information processing, the member code is correlated with the transaction ID. Member information (or a member code) may be for a store member and/or an electronic receipt member.

The commodity registration processing unit 103 and the commodity registration processing unit 503 function as an example of a transaction information generating unit that generates transaction information based on a commodity registration process and performs commodity registration processing (ACT 15, 16, 25, and 36). The commodity registration processing is processing for collecting registered commodity information and editing the transaction information 25 for the transaction. Specifically, the commodity registration processing unit 503 receives input of a commodity code via the operation unit 56 and the imaging unit 58. The commodity registration processing unit 103 acquires commodity information (a commodity name, a unit price, and the like) correlated with the commodity code and registers the commodity code and the commodity information in the transaction information 25.

Further, the settlement processing unit 104 and the settlement processing unit 504 perform settlement processing (also referred to as checkout processing) corresponding to the transaction information 25 (ACTS 17, 18, 37, and 38). In the settlement processing, payment of a price for registered items may be made by cash settlement, credit settlement, electronic money settlement, or the like.

The settlement processing unit 504 requests the receipt output processing unit 106 functioning as the printing data generating unit to generate the paper receipt printing data 27 (ACT 22).

If a member code of an electronic receipt member is acquired during a transaction, the settlement processing unit 504 requests the receipt output processing unit 106 functioning as the electronic receipt generating unit to generate the electronic receipt linkage data 28 (ACTS 23 and 24). More specifically, the settlement processing unit 504 determines based on electronic receipt member identification information whether a customer is an electronic receipt member.

The receipt output processing unit 106 operates in response to a result of the settlement processing and functions as an example of the printing data generating unit or an example of the electronic receipt generating unit.

The receipt output processing unit 106 functioning as the printing data generating unit generates the paper receipt printing data 27 corresponding to the transaction information 25 (ACTS 41 and 42).

The receipt output processing unit 106 functioning as an example of the electronic receipt generating unit generates the electronic receipt linkage data 28 corresponding to the transaction information 25 and transmits the electronic receipt linkage data 28 to the API 306 (ACTS 43 and 44).

The API 306 of the electronic receipt server 3 functions as the electronic receipt generating unit in cooperation with the receipt output processing unit 106 and generates data (electronic receipt data) using the electronic receipt linkage data 28 for displaying an electronic receipt on the terminal apparatus.

The transaction information storage processing unit 105 operates after the settlement processing (ACTS 19 to 21) and generates or updates information to be stored by the DB 2 (ACTS 39 and 40).

FIG. 12 is a diagram illustrating an example of processing executed by the control unit 50 of the tablet POS 5.

When the operation unit 56 receives an instructing of a transaction start (Yes in ACT 11), the control unit 50 (the transaction start processing unit 501) transmits a signal indicating a transaction start request to the transaction system server 1 (ACT 12).

Subsequently, if a member code is input by the imaging unit 58 or the operation unit 56 (Yes in ACT 13), the control unit 50 (the member information processing unit 502) transmits the member code to the transaction system server 1 (ACT 14). If a member code is not acquired (No in ACT 13), the control unit 50 skips ACT 14 and advances the processing to ACT 15.

Note that, for simplicity of explanation, the acquisition and the transmission of the member code are described as performed in ACTS 13 and 14. However, generally, the acquisition and the transmission of the member code may be performed at any time between the transaction start to settlement operation (Yes in ACT 17). The member information processing covers both a store member and an electronic receipt member.

Subsequently, the control unit 50 (the commodity registration processing unit 503) stands by (waits) (No in ACT 15) for input of a commodity code. If a commodity code is input via the operation unit 56 or the imaging unit 58 (Yes in ACT 15), the control unit 50 transmits a commodity registration request to the transaction system server 1 (ACT 16). In the commodity registration request, the acquired commodity code is transmitted to the transaction system server 1.

Until a settlement operation is performed (ACT 17), the control unit 50 receives commodity registration(s) (ACTS 15 and 16). When the operation unit 56 receives a settlement operation (Yes in ACT 17), the control unit 50 (the settlement processing unit 504) transmits a signal indicating a settlement request to the transaction system server 1 (ACT 18).

Subsequently, the control unit 50 (as the settlement processing unit 504) performs a balance check (ACT 19). If payment of a full amount of prices of commodities to be purchased is completed and there is no remaining balance (Yes in ACT 19) after the settlement processing, the control unit 50 (as the settlement processing unit 504) transmits a signal indicating a transaction completion request to the transaction system server 1 (ACT 20).

Note that, if there is a remaining balance (if payment is not completed) (No in ACT 19), the control unit 50 performs additional payment processing (ACT 21) and then returns the processing to ACT 19. The additional payment processing may be performed if payment by pre-charged-type electronic money is insufficient leaving a remaining balance, and additional payment by cash or the like is necessary.

Subsequently, the control unit 50 (as the settlement processing unit 504) transmits a signal indicating a paper receipt printing data generation request to the transaction system server 1 (ACT 22).

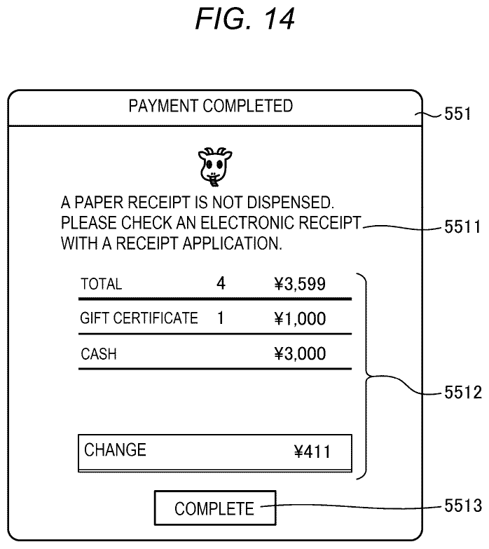

If a member code of an electronic receipt member was acquired from the customer in the transaction, the control unit 50 (as the settlement processing unit 504) handles the customer as an electronic receipt member (Yes in ACT 23) and transmits a signal indicating an electronic receipt linkage request to the transaction system server 1 (ACT 24). The control unit 50 receives a response to the electronic receipt linkage request and displays a transaction completion screen (see FIG. 14) (ACT 25). In this example, it is assumed t that, before ACT 24, the transaction system server 1 determines that the customer is an electronic receipt member.

If the customer is not an electronic receipt member (No in ACT 23), the control unit 50 (as the settlement processing unit 504) performs a paper receipt printing request for processing on the printer 7. In the paper receipt printing request processing, the paper receipt printing data 27 received as a response to the request performed in ACT 22 is transmitted to the printer 7.

FIG. 13 is a diagram illustrating an example of processing executed by the control unit 10 of the transaction system server 1.

When a transaction start request is received from the tablet POS 5 (Yes in ACT 31), the control unit 10 (as the transaction start processing unit 101) issues a transaction ID, transmits the transaction ID to the tablet POS 5, generates the transaction information 25 identified by the transaction ID, and causes the DB 2 to store the transaction information 25 (ACT 32).

Subsequently, the control unit 10 (as the member information processing unit 102) acquires member information if a member code was received from the tablet POS 5 (Yes in ACT 33) and correlates the member code to the transaction ID (ACT 34). Specifically, the control unit 10 includes the member code (or description related thereto) in the transaction information 25 (the JSON format) for the relevant transaction ID. If a member code was not received (No in ACT 33), the control unit 10 skips ACT 34 and advances the processing to ACT 35.

Note that, for simplicity of explanation, the acquisition of member information is described as performed in ACTS 33 and 34. However, the acquisition of member information may be performed at any time between the transaction start to the settlement operation (Yes in ACT 37). The member information processing covers both a store member and an electronic receipt member.

Subsequently, the control unit 10 (as the commodity registration processing unit 103) stands by (waits) for reception of a commodity registration request (ACT 35). If a commodity registration request is received (Yes in ACT 35), the control unit 10 acquires, from the commodity master 21 in the DB 2, commodity information matching the commodity code included in the commodity registration request and adds (registers) the commodity information in the transaction information 25 (ACT 36).

Until a settlement request is received (ACT 37), the control unit 10 receives commodity registrations (ACTS 35 and 36). After a settlement request is received (Yes in ACT 37), the control unit 10 (as the settlement processing unit 104) performs settlement processing (ACT 38).

Subsequently, the control unit 10 (as the transaction information storage processing unit 105) stands by (No in ACT 39) for reception of a transaction completion request and, once a transaction completion request is received (Yes in ACT 39), ends the editing of the transaction information 25 and stores the transaction information 25 (ACT 40).

Subsequently, if a signal indicating a paper receipt printing data generation request is received (Yes in ACT 41), the control unit 10 (as the receipt output processing unit 106) generates the HTML data 26 (obtained by structuring the transaction information 25 in the JSON format) and further generates the paper receipt printing data 27 by editing the HTML data 26. At this time, if a member code of an electronic receipt member was not received, the control unit 10 sets a printing flag in the paper receipt printing data 27 and transmits the paper receipt printing data 27 to the tablet POS 5 (ACT 42). The tablet POS 5 performs paper receipt printing processing according to the setting of the printing flag.

If a paper receipt printing data generation request is not received (No in ACT 41), the control unit 10 (as the receipt output processing unit 106) ends this processing and returns the processing to ACT 31. For example, if the electronic receipt dispensing is finished, the paper receipt printing data generation request is not transmitted. The control unit 10 does not receive the paper receipt printing data generation request in that case.

Further, if a signal indicating an electronic receipt linkage request is received (Yes in ACT 43), the control unit 10 (as the receipt output processing unit 106) performs electronic receipt linkage processing (ACT 44). In the electronic receipt linkage processing, the control unit 10 (as the receipt output processing unit 106) generates the electronic receipt linkage data 28 from the transaction information 25 and transmits the electronic receipt linkage data 28 to the electronic receipt server 3.

If an electronic receipt linkage request is not received (No in ACT 43), the control unit 10 (as the receipt output processing unit 106) skips ACT 44, ends this processing, and returns the processing to ACT 31.

In the electronic receipt server 3, when the electronic receipt linkage data 28 is received, the API 306 for generating electronic receipt data operates. The API 306 generates electronic receipt data using the electronic receipt linkage data 28. That is, the API 306 generates the needed data for displaying an electronic receipt of the current transaction on a customer's terminal apparatus or the like.

FIG. 14 is a diagram illustrating an example of a transaction completion screen displayed by the tablet POS 5. In ACT 25, the control unit 50 of the tablet POS 5 causes the display unit 55 to display a transaction completion screen 551. The transaction completion screen 551 includes, for example, a message 5511, payment details 5512, and an operation piece 5513.

In the case of transition from ACT 24, the message 5511 is, for example, “A paper receipt is not dispensed. Please check an electronic receipt with a receipt application.” The message 5511 in the case of transition from ACT 26 is, for example, “A paper receipt is dispensed.”

The payment details 5512 are content corresponding to settlement content. The operation piece 5513 receives operation for closing the transaction completion screen 551. If the operation piece 5513 is operated, the transaction completion screen 551 closes. The display of the display unit 55 transitions to display for receiving a start of a new transaction.

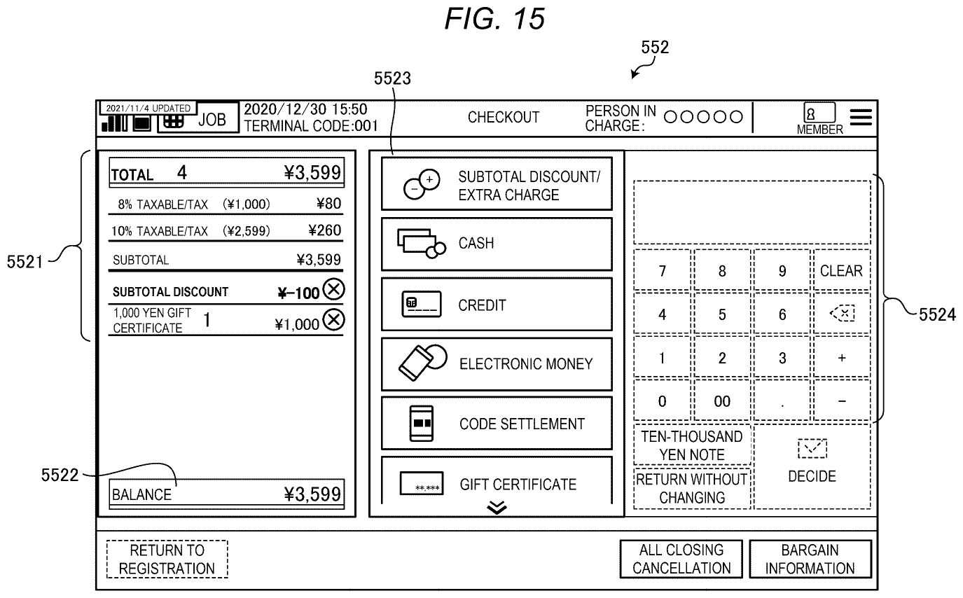

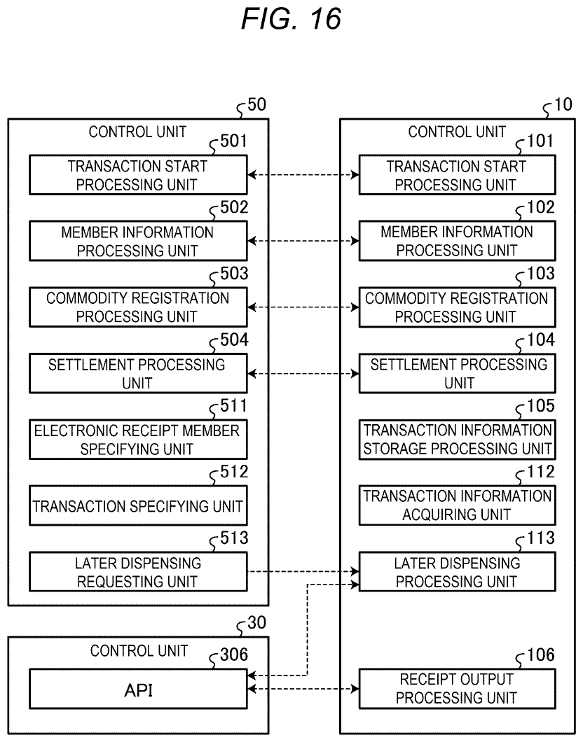

FIG. 15 is a diagram illustrating an example of a balance screen displayed by the tablet POS 5. In ACTS 18 and 21, the control unit 50 of the tablet POS 5 causes the display unit 55 to display a balance screen 552. The balance screen 552 is displayed during settlement processing for receiving operations for paying the transaction price.

The balance screen 552 includes payment details 5521, a balance 5522, and operation pieces 5523 and 5524. The payment details 5521 include a total of prices for purchase commodities, a tax amount for each applicable tax rate, and a discount amount. The balance 5522 displays an amount that should be paid. The operation pieces 5523 (buttons or icons) receive a selection of payment means. The available payment means may be, for example, cash, credit settlement, electronic money settlement, code settlement, or a gift certificate. The operation piece 5524 (number pad) receives, for example, input of a numerical value and receives input of an amount to be paid by the payment means selected by the operation pieces 5523. The operation piece 5524 exemplified in FIG. 15 is in an inoperable state. The operation piece 5524 comes into an operable state after any one of the operation pieces 5223 is selected. The operation piece 5524 depicted in FIG. 15 is depicted in the inoperable state. The operation piece 5524 comes into an operable state after any one of the operation pieces 5523 is selected.

In the system explained above, electronic receipt data for displaying an electronic receipt can be generated according to processing in a POS terminal such as the tablet POS 5. A paper receipt can be dispensed according to necessity. That is, it is possible not to dispense the paper receipt if electronic receipt data is generated.

Since the API 306 that generates electronic receipt data is provided outside the flow of processing in the transaction in this system, processing relating to generation of an electronic receipt and processing relating to the transaction can be individually and separately maintained.

Note that, in an embodiment explained above, the transaction system server 1 and the electronic receipt server 3 are separated. However, in other examples, the transaction system server 1 and the electronic receipt server 3 may be implemented by the same server.

The transaction system server 1 may be implemented as a plurality of servers. That is, the various functional units included in the transaction system server 1 in the embodiment may be provided separately among the plurality of servers.

The DB 2 may be included in the transaction system server 1. Alternatively, the storage unit 19 of the transaction system server 1 may store a part or all of the commodity master 21, the store member information 22, the electronic receipt member identification information, the transaction information 25, the HTML data 26, the paper receipt printing data 27, and the electronic receipt linkage data 28 stored by the DB 2.

Certain functional units described as included in the transaction system server 1 in an embodiment may instead be provided in a POS terminal.

The electronic receipt dispensing system according to the first embodiment includes the tablet POS 5 (as a commodity registration apparatus) that is capable of reading electronic receipt member identifying information from a terminal apparatus or the like, the transaction system server 1 (as a first information processing apparatus) capable of communicating with the commodity registration apparatus, and the electronic receipt server 3 (as a second information processing apparatus) capable of communicating with the transaction system server 1 and the terminal apparatus. The electronic receipt dispensing system outputs electronic receipt data in response to an output request from the terminal apparatus.

The tablet POS 5 (commodity registration apparatus) includes the commodity registration processing unit 503 (as a transaction processing side transmission unit) that receives a commodity code of a commodity to be registered and transmits a commodity registration request including the commodity code to the first information processing apparatus (transaction system server 1). The tablet POS 5 also includes a member information processing unit 502 to transmit a member code or the like to the first information processing apparatus (transaction system server 1) whenever electronic receipt member identifying information is acquired

The transaction system server 1 includes the commodity registration processing unit 103, the settlement processing unit 104 (as a determining unit) that determines whether to generate electronic receipt data, and the receipt output processing unit 106 that generates electronic receipt linkage data including the electronic receipt member identifying information. The electronic receipt linkage data is based on the transaction information, and transmitted the electronic receipt server 3 (the second information processing apparatus).

The electronic receipt server 3 includes the API 306 (as an electronic receipt generating unit) that generates electronic receipt data based on the electronic receipt linkage data. The electronic receipt data storage unit 39 stores the electronic receipt data in correlation with the electronic receipt member identifying information. The electronic receipt server 3 also includes a providing unit that provides the electronic receipt data to a terminal apparatus upon request.

As explained above, in the electronic receipt dispensing system, by separating the transaction system server and the electronic receipt server, it is possible to separate the processing related to transaction information generating and handling from the processing specifically related to provision of an electronic receipt. This makes it possible to facilitate maintenance for the respective kinds of processing systems. In particular, the transaction system server 1 may be a multi-tenant system in which a plurality of companies can share one server. The transaction system server 1 can perform, simultaneously for this plurality of companies, processing relating to transaction information. Users of the transaction system server 1 can then more easily implement an electronic receipt dispensing system by providing separate electronic receipt servers 3.

Note that the electronic receipt member identifying information may be information including an electronic receipt member code specific to an electronic receipt member and/or a member flag indicating whether a customer is an electronic receipt member. In this case, the settlement processing unit 104 of the transaction system server 1 may determine whether to generate electronic receipt data according to the member flag value. With this configuration, it is possible to omit processing for inquiring for every received member code whether the member code is a valid electronic receipt member.

Note that the embodiment explained above can also be modified and implemented as appropriate by changing various parts, aspects, components, functions and the like of the apparatuses explained above. However, in the following explanation, certain modifications are explained as additional embodiments. Note that, in the following explanation, differences from the embodiment already explained above are mainly explained. Aspects explained above that are substantially similar to those in the other embodiments are denoted by the same reference numerals and signs and detailed explanation of these similar aspects may be omitted. The modifications explained below may be individually implemented or may be implemented in combination with each other when possible.

### Second Embodiment

In a second embodiment, a function of dispensing an electronic receipt at a later date (a date after transaction completion) is explained.

For example, it is assumed that a customer visiting a store requests to dispense an electronic receipt for a completed transaction by, for example, showing a transaction ID of the transaction. In this case, a store clerk performs, on the tablet POS 5, an operation for dispensing an electronic receipt.

Note that, in the following explanation, the tablet POS 5 is on a selling floor or at a service counter and may be operated by a store clerk. However, in other examples, another POS terminal or store terminal (a store server) provided in a backroom of the store may provide the described functions of tablet POS 5.

FIG. 16 is a block diagram illustrating an example of the functional components included in the control units 10, 30, and 50 in the second embodiment. The control unit 50 of the tablet POS 5 includes an electronic receipt member specifying unit 511, a transaction specifying unit 512, and a later dispensing requesting unit 513. The control unit 10 of the transaction system server 1 includes a transaction information acquiring unit 112 and a later dispensing processing unit 113. The later dispensing processing unit 113 functions an example of the electronic receipt generating unit in conjunction with the API 306.

The transaction information acquiring unit 112 acquires specific transaction information 25 from the DB 2 relating to a completed transaction. The later dispensing requesting unit 513 requests the electronic receipt generating unit (comprising later dispensing processing unit 113 and API 306) to generate electronic receipt data corresponding to the acquired transaction information 25.

The electronic receipt member specifying unit 511 is an example of the member information receiving unit. The electronic receipt member specifying unit 511 operates if electronic receipt linkage processing is selected from a job menu and receives input of a member code of an electronic receipt member. The customer presents a member code to the store clerk via a display screen of a customer terminal or otherwise.

The transaction specifying unit 512 receives input of a transaction ID from the customer.

The later dispensing requesting unit 513 transmits a signal (a dispensing request including the transaction ID) for requesting an electronic receipt to the transaction system server 1.

After the dispensing request is received, the transaction information acquiring unit 112 acquires, from the DB 2, the transaction information 25 matching the transaction ID.

The later dispensing processing unit 113 generates electronic receipt linkage data 28 based on the transaction information 25 in the JSON format. The later dispensing processing unit 113 transmits the electronic receipt linkage data 28 to the electronic receipt server 3.

Processing in the electronic receipt server 3 is the same as the processing in the first embodiment. In the electronic receipt server 3, once the electronic receipt linkage data 28 is received, the API 306 for generating electronic receipt data operates. The API 306 generates electronic receipt data using the electronic receipt linkage data 28. That is, the API 306 generates new data for displaying an electronic receipt of a selected transaction on the terminal apparatus.

From the above, if the electronic receipt member failed to present member information during a transaction, electronic receipt data can still be generated after the transaction. For example, transaction information 25 for a transaction performed before the customer became an electronic receipt member may still be generated as an electronic receipt if the customer presents a paper receipt and then requests an electronic receipt. Alternatively, if a customer who was only a store member signs up to also become an electronic receipt member, it is possible to extract the previous transaction information 25 from the DB 2 by correlating an electronic receipt member code to the store member code. It is thus possible to generate electronic receipt data for a store member based on the stored transaction information 25 associated with the store member code.

Note that, if the HTML data 26 matching the transaction ID remains in the DB 2, the control unit 10 of the transaction system server 1 may use the HTML data 26 without acquiring the corresponding transaction information 25.

### Third Embodiment

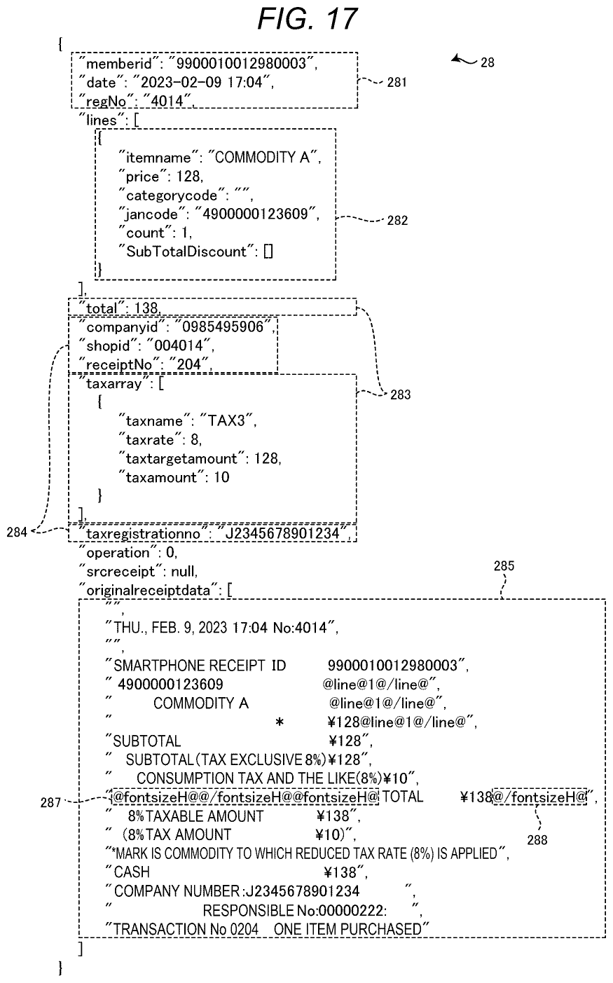

FIG. 17 is a diagram illustrating an example of the electronic receipt linkage data 28 stored by the DB 2 in a third embodiment. The electronic receipt linkage data 28 in this third embodiment further includes information 285 in addition to the information that was illustrated in FIG. 9. The information 285 is generated by editing the HTML data 26. That is, the receipt output processing unit 106 in this third embodiment generates the electronic receipt linkage data 28 including information 281 to 284 based on the transaction information 25 and the information 285 based on the HTML data 26.

The information 285 includes information for designating a format corresponding to a paper receipt and includes, for example, information 287 and 288 added using attributes 267 and 268 in the HTML data 26. Note that the information 287 and 288 here provides a designation for increasing a font size of a row indicating a total. In this way, the information 285 generated based on the HTML data 26 includes the information for designating the format corresponding to a paper receipt.

When the electronic receipt linkage data 28 includes the information 285, the API 306 can generate electronic receipt data using the information 285 rather than the information 281 to 284. Accordingly, a format similar to the paper receipt can be substantially matched by an electronic receipt displayed on a terminal apparatus used by a customer in this embodiment.

Note that the control unit 30 of the electronic receipt server 3 causes a predetermined storage unit to store (accumulate) the information 281 to 284. For example, the information 281 to 284 includes item names and information. Items are, for example, a transaction date (date), a commodity name (itemname), a unit price (price), a total (total), a commodity code (jancode), a company ID (companyid), and a store ID (shopid). The information is values corresponding to the items. The control unit 30 causes the predetermined storage unit to store, for example, in a format of a table including the items, information corresponding to the items included in the information 281 to 284. Accordingly, information included in the electronic receipt linkage data 28 can be accumulated to be usable for uses such as statistics and various analyses.

The electronic receipt dispensing system according to the third embodiment includes a tablet POS 5 capable of reading electronic receipt member identifying information from a customer terminal apparatus, a transaction system server 1 (a first information processing apparatus) capable of communicating with the tablet POS 5, and the electronic receipt server 3 (a second information processing apparatus) capable of communicating with the transaction system server 1 and the customer's terminal apparatus. The electronic receipt dispensing system provides electronic receipt data in response to a reference request from the terminal apparatus.

The tablet POS 5 includes the commodity registration processing unit 503 that receives a commodity code of a commodity to be registered and transmits a commodity registration request including the commodity code to the first information processing apparatus. The tablet POS 5 also includes member information processing unit 502 that transmits the electronic receipt member identifying information whenever acquired from the terminal apparatus to the transaction system server 1.

The transaction system server 1 (the first information processing apparatus) includes the commodity registration processing unit 103, a structured data generating unit that generates structured data (HTML data) for generating, from transaction information, paper receipt printing data for a printer, the settlement processing unit 104 (a determining unit) that determines whether to generate electronic receipt data, and the receipt output processing unit 106 that generates electronic receipt linkage data and information for designating a format corresponding to the paper receipt. The electronic receipt linkage data is based on a structured data format and is transmitted to the electronic receipt server 3 (second information processing apparatus).

The electronic receipt server 3 includes API 306 (as an electronic receipt generating unit) that generates electronic receipt data from the electronic receipt linkage data, the electronic receipt data storage unit 39 that stores the electronic receipt data in correlation with the electronic receipt member identifying information, and a providing unit that provides the electronic receipt data to a terminal apparatus upon request.

By separating the transaction system server 1 and the electronic receipt server 3, it is possible to separate processing related to transaction information and processing related to electronic receipt generation. In particular, the transaction system server 1 can be a multi-tenant system in which a plurality of companies can share one server. The transaction system server 1 can perform, simultaneously for the plurality of companies, the processing relating to transaction information. Users of the transaction system server 1 can more easily implement an electronic receipt dispensing system by separately providing electronic receipt servers 3. In the transaction system server 1, since transaction information is stored in a form of structured data, it is possible to provide transaction information that is easily processed and has high versatility.

Note that the electronic receipt linkage data may include two or more of a commodity unit price, a commodity purchase date and time, a purchaser attribute, and a purchase area. In this case, the electronic receipt server 3 may further include an analyzing unit that analyzes correlations between the commodity unit prices, the commodity purchase date and times, the purchaser attributes, and the purchase areas.

Note that the electronic receipt member identifying information may be information including an electronic receipt member code specific to an electronic receipt member and/or a member flag indicating whether a customer is an electronic receipt member.

### Fourth Embodiment

In a fourth embodiment, image data used as a logo on a receipt is stored in the storage unit 39 of the electronic receipt server 3 in correlation with a company ID. Here, the image data is one example of fixed-format data used, together with the electronic receipt linkage data 28, for generating electronic receipt data. The company ID is an example of identification information included in the electronic receipt linkage data 28. The company ID is included in the transaction information 25 and is included in the HTML data 26 and the electronic receipt linkage data 28.

If the electronic receipt linkage data 28 includes the company ID, the API 306 in this fourth embodiment generates electronic receipt data such that image data matching (linked to) the company ID stored in the storage unit 39 is displayed in a header of an electronic receipt. That is, the API 306 adds the image data to a header portion of electronic receipt data or includes link information to the image data in the header portion.

Note that the company ID need not always be included in the electronic receipt linkage data 28. If the electronic receipt linkage data 28 does not include the company ID, a similar effect can be obtained if the receipt output processing unit 106 transmits the electronic receipt linkage data 28 to the electronic receipt server 3 with the company ID attached to the electronic receipt linkage data 28. The API 306 then generates electronic receipt data using the electronic receipt linkage data 28 and the company ID.

According to this fourth embodiment, if the electronic receipt dispensing system is configured to cause a display unit to display a logo image on an electronic receipt, image data does not have to be transmitted from the transaction system server 1. This makes it possible to reduce a communication data amount.

The electronic receipt dispensing system according to the fourth embodiment includes a tablet POS 5 (a commodity registration apparatus) capable of reading electronic receipt member identifying information, the transaction system server 1 capable of communicating with the commodity registration apparatus, and the electronic receipt server 3 capable of communicating with the transaction system server 1 and the terminal apparatus. The electronic receipt dispensing system provides electronic receipt data in response to a reference request from the terminal apparatus.

The tablet POS 5 includes the commodity registration processing unit 503 that receives a commodity code of a commodity to be registered for settlement processing and transmits a commodity registration request including the commodity code and company identification information to the transaction system server 1. The tablet POS 5 also includes the member information processing unit 502 that, when the electronic receipt member identifying information is acquired from a terminal apparatus, transmits the electronic receipt member identifying information to the transaction system server 1.

The transaction system server 1 includes the commodity registration processing unit 103 that generates transaction information based on the commodity code and the company identification information, the settlement processing unit 104 that determines whether to generate electronic receipt data the according to electronic member identifying receipt information, and the receipt output processing unit 106 that, if it is determined to generate the electronic receipt data, generates electronic receipt linkage data including the electronic receipt member identifying information and the company identification information. The electronic receipt linkage data is based on the transaction data and transmitted to the electronic receipt server 3. The transaction system server 1 and the electronic receipt server 3 are separate, independently operable devices.

The electronic receipt server 3 includes a fixed-form data storage unit 39 that stores fixed-form data (e.g., image data) correlated with the company identification information, and the API 306 that generates electronic receipt data based on the electronic receipt linkage data and the fixed-form data. The electronic receipt data storage unit 39 stores the electronic receipt data in correlation with the electronic receipt member identifying information, The electronic receipt server 3 has a providing unit that, when a reference request including the electronic receipt member identifying information is received from a terminal apparatus, provides the electronic receipt data to the terminal apparatus to enable a customer to view the electronic receipt data.

By separating the transaction system server 1 and the electronic receipt server 3 in the electronic receipt dispensing system, it is possible to separate processing relating to transaction information and processing relating to an electronic receipt. This makes it possible to facilitate maintenance related to the respective kinds of processing. In particular, the transaction system server 1 is a multi-tenant system in which a plurality of companies can share one server. The transaction system server 1 can perform, simultaneously for the plurality of companies, maintenance for the processing relating to transaction information. Users of the transaction system server 1 can easily implement the electronic receipt dispensing system by separately providing electronic receipt servers 3. In the transaction system server 1, since transaction information is stored in a form of structured data, it is possible to provide, in response to a request, transaction information that is easily processed and has high versatility.

Note that, with the configuration explained above, if the fixed-form data (the image data) has a larger volume than the electronic receipt linkage data, it may be unnecessary to transmit the fixed-form data from the transaction system server 1 to the electronic receipt server 3 every time the electronic receipt data is generated. Therefore, it is possible to reduce communication between the transaction system server 1 and the electronic receipt server 3.

Note that the electronic receipt member identifying information may be information including an electronic receipt member code specific to an electronic receipt member and/or a member flag value indicating whether a customer is an electronic receipt member. In this case, the settlement processing unit 104 of the transaction system server 1 may determine whether to generate electronic receipt data according to the member flag. With this configuration, it is possible to omit processing for inquiring, every time, based on a member code about an electronic receipt member, when a customer is an electronic receipt member.

### Fifth Embodiment

A fifth embodiment is a modification of the second embodiment. In the second embodiment, the later dispensing processing unit 113 generates the electronic receipt linkage data 28 based on the transaction information 25 acquired by the transaction information acquiring unit 112.

In contrast, in this fifth embodiment, if HTML data 26 matching a transaction ID is stored in the DB 2, the transaction information acquiring unit 112 also acquires the HTML data 26. After the transaction information acquiring unit 112 has acquired the HTML data 26, the later dispensing processing unit 113 generates, using the HTML data 26, information 285 to be included in the electronic receipt linkage data 28.

If the transaction information acquiring unit 112 does not acquire the HTML data 26, the later dispensing processing unit 113 in this fifth embodiment structures the transaction information 25 to generate the HTML data 26 and then generates, from the HTML data 26, the information 285 to be included in the electronic receipt linkage data 28. Note that the later dispensing processing unit 113 may also perform processing for causing the DB 2 to store the HTML data 26 that is generated by the later dispensing processing unit 113.

According to the fifth embodiment, even if an electronic receipt is dispensed on a later date after transaction completion, the information 285 for designating a format can be included in the electronic receipt linkage data 28. Accordingly, a format corresponding to a paper receipt may be reflected on an electronic receipt displayed on a terminal apparatus used by a user.

Programs executed in the apparatuses in the embodiments explained above may be incorporated in a ROM or the like in advance. These programs may be provided by being recorded in a computer-readable recording medium such as a CD-ROM, a flexible disk (FD), a CD-R, or a DVD (Digital Versatile Disk) as a file of an installable format or an executable format.

Further, the programs may be provided by being stored on a computer connected to a network, such as the Internet, and downloaded through the network. The programs may be provided or distributed across a network such as the Internet.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

### Notes

### Supplementary Note 1

Certain embodiments include the following:

An electronic receipt dispensing system including: a commodity registration apparatus (a tablet POS 5) capable of reading electronic receipt member identifying information from a terminal apparatus; a first information processing apparatus (a transaction system server 1) capable of communicating with the commodity registration apparatus; and a second information processing apparatus (an electronic receipt server 3) capable of communicating with the first information processing apparatus and the terminal apparatus, the electronic receipt dispensing system outputting electronic receipt data in response to an output request from the terminal apparatus. The commodity registration apparatus includes: a transaction processing side transmission unit 503 configured to receive a commodity code of a commodity to be registered for settlement processing and transmit a commodity registration request including the commodity code to the first information processing apparatus; and a member information processing unit 502 configured to, in the registration of the commodity, if the electronic receipt member identifying information is acquired from the terminal apparatus, transmit the electronic receipt member identifying information to the first information processing apparatus. The first information processing apparatus includes: an information processing side commodity registration processing unit 103 configured to, if the commodity registration request is received, generate transaction information based on the commodity code; a determining unit configured to determine whether to generate electronic receipt data according to the electronic receipt member identifying information; and a receipt output processing unit 106 configured to, if it is determined to generate the electronic receipt data, generate electronic receipt linkage data including the electronic receipt member identifying information, the electronic receipt linkage data being based on the transaction information, and transmit the electronic receipt linkage data to the second information processing apparatus. The second information processing apparatus includes: an electronic receipt generating unit 306 configured to generate the electronic receipt data based on the electronic receipt linkage data; an electronic receipt data storage unit 39 configured to store the electronic receipt data in correlation with the electronic receipt member identifying information; and a providing unit configured to, if a reference request including the electronic receipt member identifying information is received from the terminal apparatus, provide the electronic receipt data to the terminal apparatus to enable a customer to refer to the electronic receipt data.

### Supplementary Note 2

An electronic receipt dispensing system including: a commodity registration apparatus (a tablet POS 5) capable of reading electronic receipt member identifying information from a terminal apparatus; a first information processing apparatus (a transaction system server 1) capable of communicating with the commodity registration apparatus; and a second information processing apparatus (an electronic receipt server 3) capable of communicating with the first information processing apparatus and the terminal apparatus, the electronic receipt dispensing system providing electronic receipt data in response to a reference request from the terminal apparatus. The commodity registration apparatus includes: a transaction processing side transmission unit 503 configured to receive a commodity code of a commodity to be registered for settlement processing and transmit a commodity registration request including the commodity code to the first information processing apparatus; and a member information processing unit 502 configured to, in the registration of the commodity, if the electronic receipt member identifying information is acquired from the terminal apparatus, transmit the electronic receipt member identifying information to the first information processing apparatus. The first information processing apparatus includes: an information processing side commodity registration processing unit 103 configured to, if the commodity registration request is received, generate transaction information based on the commodity code; a structured data generating unit configured to generate structured data (HTML data) capable of generating, from the transaction information, paper receipt printing data for causing a printer to dispense a paper receipt; a determining unit configured to determine whether to generate electronic receipt data according to the electronic receipt member identifying information; and a receipt output processing unit 106 configured to, if it is determined to generate the electronic receipt data, generate electronic receipt linkage data including the electronic receipt member identifying information and information for designating a format corresponding to the paper receipt, the electronic receipt linkage data being based on the structured data, and transmit the electronic receipt linkage data to the second information processing apparatus. The second information processing apparatus (the electronic receipt server 3) includes: an electronic receipt generating unit 306 configured to generate the electronic receipt data based on the electronic receipt linkage data; an electronic receipt data storage unit 39 configured to store the electronic receipt data in correlation with the electronic receipt member identifying information; and a providing unit configured to, if a reference request including the electronic receipt member identifying information is received from the terminal apparatus, provide the electronic receipt data to the terminal apparatus to enable a customer to refer to the electronic receipt data.

### Supplementary Note 3

An electronic receipt dispensing system including: a commodity registration apparatus (a tablet POS 5) capable of reading electronic receipt member identifying information from a terminal apparatus; a first information processing apparatus (a transaction system server 1) capable of communicating with the commodity registration apparatus; and a second information processing apparatus (an electronic receipt server 3) capable of communicating with the first information processing apparatus and the terminal apparatus, the electronic receipt dispensing system providing electronic receipt data in response to a reference request from the terminal apparatus. The commodity registration apparatus includes: a transaction processing side transmission unit 503 configured to receive a commodity code of a commodity to be registered for settlement processing and transmit a commodity registration request including the commodity code and company identification information to the first information processing apparatus; and a member information processing unit 502 configured to, in the registration of the commodity, if the electronic receipt member identifying information is acquired from the terminal apparatus, transmit the electronic receipt member identifying information to the first information processing apparatus. The first information processing apparatus includes: an information processing side commodity registration processing unit 103 configured to, if the commodity registration request is received, generate transaction information based on the commodity code and the company identification information; a determining unit configured to determine whether to generate electronic receipt data according to the electronic receipt member identifying information; and a receipt output processing unit 106 configured to, if it is determined to generate the electronic receipt data, generate electronic receipt linkage data including the electronic receipt member identifying information and the company identification information, the electronic receipt linkage data being based on the transaction information, and transmit the electronic receipt linkage data to the second information processing apparatus. The second information processing apparatus includes: a fixed-form data storage unit configured to store fixed-form data correlated with the company identification information; an electronic receipt generating unit 306 configured to generate the electronic receipt data based on the electronic receipt linkage data and the fixed-form data; an electronic receipt data storage unit 39 configured to store the electronic receipt data in correlation with the electronic receipt member identifying information; and a providing unit configured to, if a reference request including the electronic receipt member identifying information is received from the terminal apparatus, provide the electronic receipt data to the terminal apparatus to enable a customer to refer to the electronic receipt data.

What is claimed is:

1. A sales transaction processing system, comprising:
a point-of-sale terminal in a store;
a printer in the store for printing transaction receipts;
a transaction system server connected to the point-of-sale terminal via a first network and configured to:
receive a commodity code of an item being registered for purchase in a sales transaction at the point-of-sale terminal and register the item in transaction data for the sales transaction;
receive a member code for a customer in the sales transaction;
generate printing data for printing a transaction receipt for the sales transaction on the printer, the transaction receipt being based on the transaction data for the sales transaction; and
if the received member code indicates the customer is a member of an electronic receipt service, generate linkage data from the printing data, the linkage data permitting an electronic receipt to be generated for the sales transaction.

2. The sales transaction processing system according to claim 1, further comprising:
an electronic receipt server connected to the transaction system server via a second network and configured to generate an electronic receipt for the sales transaction from the linkage data.

3. The sales transaction processing system according to claim 1, further comprising:
a database accessible by the transaction system server and storing linkage data, a commodity master associating commodity information to commodity codes, a store member table associating member codes to member information, and a transaction information table associating transaction IDs to transaction data.

4. The sales transaction processing system according to claim 1, wherein the point-of-sale terminal is a tablet terminal.

5. The sales transaction processing system according to the claim 1, wherein the linkage data is structured data with HTML tags.

6. The sales transaction processing system according to claim 1, wherein the transaction system server is further configured to:
receive a request for an electronic receipt for a previous sales transaction;
extract the transaction data for the previous sales transaction from a database storing transaction data and generate linkage data based on the extracted transaction data; and
output the linkage data to an electronic receipt server of the electronic receipt service.

7. The sales transaction processing system according to claim 1, wherein the point-of-sale terminal includes an imaging unit configured to read the commodity code of the item being registered in the sale transaction.

8. The sales transaction processing system according to claim 7, wherein the imaging unit is further configured to read the member code.

9. The sales transaction processing system according to claim 1, wherein the transaction system server is further configured to:
process settlement of the sales transaction based on the transaction data.

10. The sales transaction processing system according to claim 1, wherein the linkage data includes information to format the electronic receipt to match formatting of the printed transaction receipt.

11. A sales transaction system server, comprising:
a communication interface connected to a point-of-sale terminal via a first network;
a processor configured to:
receive a commodity code of an item being registered for purchase in a sales transaction at the point-of-sale terminal and register the item in transaction data for the sales transaction;
receive a member code for a customer in the sales transaction;
generate printing data for printing a transaction receipt for the sales transaction on a printer, the transaction receipt being based on the transaction data for the sales transaction; and
if the received member code indicates the customer is a member of an electronic receipt service, generate linkage data from the printing data, the linkage data permitting an electronic receipt to be generated for the sales transaction.

12. The sales transaction system server according to claim 11, wherein the communication interface is connected to an electronic receipt server via a second network.

13. The sales transaction system server according to claim 11, further comprising:
a database storing linkage data, a commodity master associating commodity information to commodity codes, a store member table associating member codes to member information, and a transaction information table associating transaction IDs to transaction data.

14. The sales transaction system server according to the claim 11, wherein the linkage data is structured data with HTML tags.

15. The sales transaction system server according to claim 11, wherein the processor is further configured to:
receive a request for an electronic receipt for a previous sales transaction;
extract the transaction data for the previous sales transaction from a database storing transaction data and generate linkage data based on the extracted transaction data; and
output the linkage data to an electronic receipt server of the electronic receipt service.

16. The sales transaction system server according to claim 11, wherein the processor is further configured to:
process settlement of the sales transaction based on the transaction data.

17. The sales transaction system server according to claim 11, wherein the linkage data includes information to format the electronic receipt to match formatting of the printed transaction receipt.

18. A sales transaction processing method for electronic receipt dispensing, the method comprising:
receiving a commodity code of an item being registered for purchase in a sales transaction at a point-of-sale terminal and registering the item in transaction data for the sales transaction;
receiving a member code for a: in the sales transaction;
generating printing data for printing a transaction receipt for the sales transaction on a printer, the transaction receipt being based on the transaction data for the sales transaction; and
if the received member code indicates the customer is a member of an electronic receipt service, generating linkage data from the printing data, the linkage data permitting an electronic receipt to be generated for the sales transaction.

19. The method according to claim 18, further comprising:
outputting the linkage data to an electronic receipt server of the electronic receipt service communication.

20. The method according to the claim 18, wherein the linkage data is structured data with HTML tags.
